(19) United States
(12) Patent Application Publication
(10) Pub. No.: US 2022/0335437 A1
(43) Pub. Date: Oct. 20, 2022

(54) CUSTOMER SERVICE SURVEY TOOL FOR PUBLIC SAFETY

(71) Applicant: Guardian Score, LLC, Ashburn, VA (US)

(72) Inventors: Burke Brownfeld, Alexandria, VA (US); Brendan Hooke, Ashburn, VA (US); Mohammed Kassem, Dearborn, MI (US); Moussa Harajli, Northville, MI (US); Joshua Davis, San Diego, CA (US)

(21) Appl. No.: 17/722,507

(22) Filed: Apr. 18, 2022

Related U.S. Application Data
(60) Provisional application No. 63/175,607, filed on Apr. 16, 2021.

(51) Int. Cl. G06Q 30/00; G06K 7/14

(52) U.S. Cl. CPC G06Q 30/016; G06K 7/1417

(57) ABSTRACT

A method of verifying encounters used to populate a customer service survey software, the method including issuing an interaction card having an encounter-specific Quick Response (“QR”) code to a user, scanning the QR code by the user using an electronic device, the user accessing and completing a customer service survey on the electronic device, collecting information of the customer service survey of the user by the customer service survey software, and storing the information as data in a non-transitory computer-based memory in a back-end server.

### BACKGROUND

A gap exists between law enforcement and the communities they serve, creating a perpetual cycle of violence and mistrust between police departments and their communities. Citizens may have little ability to provide timely or meaningful feedback on their police departments, and this acts as a barrier to building trust, transparency, and legitimacy. Some citizens may feel that they simply don't have a voice when it comes to providing ideas and feedback about policing.

Another other consequence of this gap is related to the concept of “we manage what we measure.” Up until now, police departments may measure things like tickets and arrests, but have never found a solution to measure things related to emotional intelligence, customer service, and other qualitative aspects that hold substantial meaning in the context of a police/citizen interaction. As long as police departments continue to not measure these qualitative items, it will be virtually impossible to incentivize or even provide a pathway for a cultural shift or change in behavior.

Many groups are calling for this problem to be solved. Some like the U.S. Department of Justice or CALEA even require departments to survey their community to measure their customer service. However, none look at verified interactions on an officer level. Websites like ratemycop.com exist, but they are based on anonymous internet comments and provide no data to help guide police departments. For the most part these solutions lack connectivity with police departments, and have not focused on linking their data to meaningful work products that police leaders can incorporate into promotional decisions, performance evaluations, or overall accountability. Furthermore, most of the companies that seek to gain feedback from citizens are set up with no effort at any verification that a real police encounter even occurred, thereby calling into question the validity of the data. Thus, existing solutions either measure a general sense of community support, fail to verify that an interaction actually occurred, or fail to provide metrics to police departments to help understand the data.

Existing survey solutions utilizing customer data to verify interactions are unsuitable for interactions between police officers and community members. Due to legal, political and privacy considerations, police departments are unlikely to demand community members provide personal information to facilitate a customer service style survey. In fact, such a demand would undermine the purpose of the survey, which is improving customer service.

The above information disclosed in this Background section is only for enhancement of understanding of the background of the inventive concept, and, therefore, it may contain information that does not form the prior art that is already known in this country to a person of ordinary skill in the art.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a flowchart illustrating a method for utilizing a customer service tool for public safety, according to an exemplary embodiment.

FIG. 2 is a flowchart further illustrating a method for utilizing a customer service tool for public safety, according to the present exemplary embodiment.

FIG. 3 shows a method for an interaction card creation process, according to an exemplary embodiment.

FIG. 4 shows a method for a survey data collection process, according to an exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Also, like reference numerals denote like elements.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Exemplary embodiments of the present inventive concept helps communities provide instant and verified feedback on police interactions without the need to download an app or to provide an email address. Exemplary embodiments help public safety entities ensure their employees are providing a high level of customer service, and is intended to help bridge the gap between law enforcement and the community.

Exemplary embodiments relate to software that allows for feedback to be tied to a specific officer and to a specific interaction, which provides a unique avenue of feedback for citizens. Exemplary embodiments also provide the client (e.g., police departments) real metrics around qualitative behaviors, that effectively have never been accurately measured before. Up until now, a police department has had no real way to measure an officer's listening skills or fairness, for example. Exemplary embodiments provide data on these qualitative behaviors, to be incorporated directly into the evaluation of the performance of an officer.

Exemplary embodiments disclose a customer service survey software application specifically designed for public safety. Due to the nature of public safety encounters it may be difficult for governing authorities to monitor public safety customer service performance in the aggregate. Unlike other industries, public safety agencies respond based on a dispatch model that does not allow for instant app-based feedback, like Uber®, and unlike commercial businesses, public safety agencies do not collect customer service information in a way that makes customer service follow-up viable, like Amazon®. Exemplary embodiments provide a solution to that problem with a low-friction solution by balancing the need to verify the source of the customer service data with the need to make the process surrounding that customer service feedback loop.

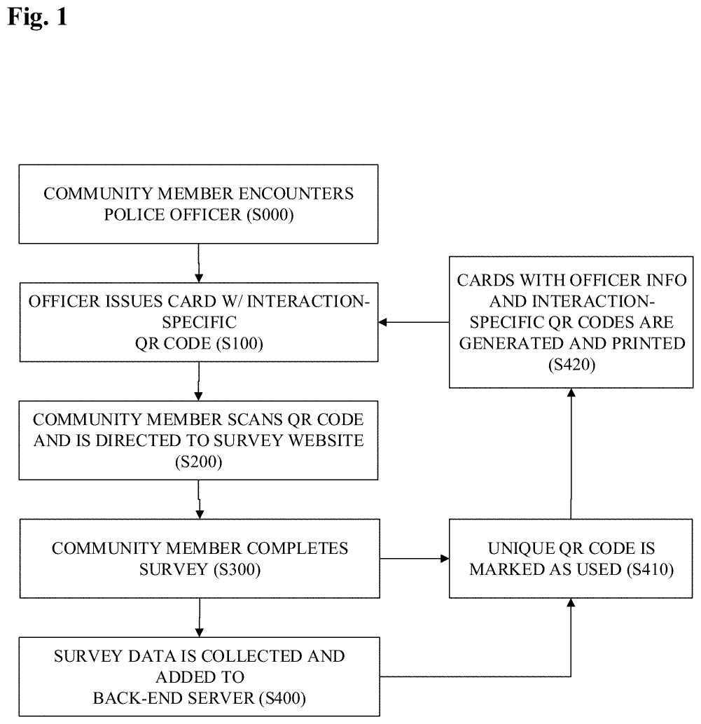

FIG. 1 is a flowchart illustrating a method for utilizing a customer service tool for public safety, according to an exemplary embodiment of the present inventive concept. Referring to FIG. 1, the method for utilizing the customer service tool is started when a community member encounters a police officer (S000). Based on that encounter, the police officer issues an interaction card with an interaction-specific Quick Response (“QR”) code S100). The community member then scans the QR code using an electronic device, and is directed to a survey website (S200), at which time the community members completes a customer service survey (S300). The user may navigate to the survey website to input a 12-digit alphanumeric code, rather than scanning the QR code. The survey information is collected and stored as data by a memory in a back-end server (S400), such as a separate computer or cloud-based non-transitory memory.

The present exemplary embodiment provides a user of the customer service survey software the ability to verify the existence of encounters used to populate the customer service analytics. The use of a unique QR code for each interaction printed to an interaction card directs survey takers to an internet survey that can only be taken once per QR code. Once that survey has been completed, that QR code and the associated link are no longer valid. The survey website becomes inaccessible once the survey is complete, so that a person cannot scan and complete the survey twice. Referring to FIG. 1, the unique QR code is marked as used once the survey is completed (S410). This step S410 may occur substantially simultaneously with the collection and storage of survey data as in step S400. Steps S000 through S400 and S410 may be repeated, for as many community member-police office interactions occur. Accordingly, new interaction cards with interaction-specific QR codes are generated and printed (S420), for use in step S100.

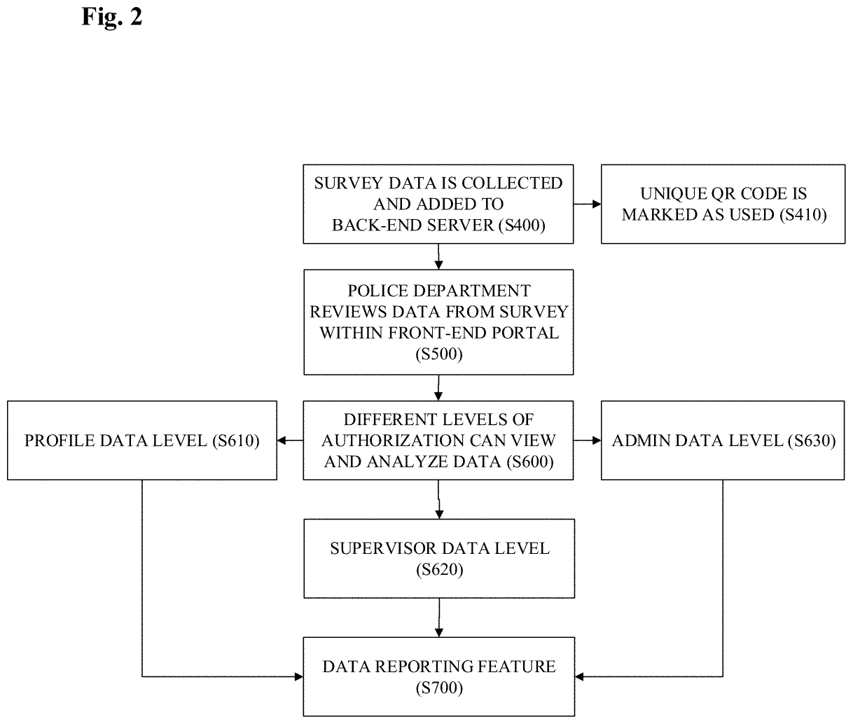

This process, as shown in FIG. 1, verifies that only people that had an interaction with a police officer, leading to the issuance of a QR code-containing interaction card, can take the survey. The data collected from this survey is captured in a database, and is transformed by and presented in the survey tool software. According to the present exemplary embodiment, the survey tool is an analytics software program which calculates metrics and allows monitoring officer, team and department performance, as described below with respect to FIG. 2. The analytics performed by the software program and resulting metrics are configured to correspond to the survey questions, which are based on procedural justice principles. The survey tool software retrieves, calculates and/or determines the resulting metrics based on the stored data in the memory and/or database.

FIG. 2 is a flowchart further illustrating the method as shown in FIG. 1 for utilizing a customer service tool for public safety. According to the present exemplary embodiment, the overall average of all the scores from each survey question is calculated in response to each community member who completes a survey, once the survey data is collected and stored per step S400. This calculation, and other analytics, may be performed automatically by the software as part of step S500, and a police department subsequently reviews the manipulated survey data within the survey tool software.

Each metric is broken down by officer, team and department, so that agencies can use that data to monitor individual officer performance, group performance and agency performance (steps S600 through S630). Survey data and other data captured in the database and stored in the back-end server can be viewed in a front-end portal (S500), such as the survey tool software. The front-end portal may be a web-based app. The back-end server determines if the user is authorized to view specific pages or features, and renders the portal for a user to view the data. The back-end server system provides a collection of permissions on privileges in the front-end portal to read, write and/or modify a set of data.

Additional features of the front-end portal may include automated reports for officer performance for inclusion in their annual report, and automated monthly team and group reports for internal compstat meetings (S700). Further, as part of the operation of the survey tool software or department review process in step S500, unique QR codes may be marked as used (S410) and new business cards with interaction-specific QR codes may be generated and printed (S420).

Both in response to crisis and as part of a natural evolution, agencies have shifted towards an emphasis on empathy and de-escalation. Traditionally, a “good officer” was defined by their productivity statistics (numbers of arrests and tickets) and a lack of sustained citizen complaints. The present inventive concept strives to transform the definition of a “good officer” through quick and easy-to-use surveys individually correlated to interaction-specific QR codes. By using a short list of targeted questions, exemplary embodiments are able to provide a score for each officer and interaction, with feedback on key skills: customer service, listening skills, professionalism, and fairness.

Exemplary embodiments of the present inventive concept can help improve annual performance evaluations, reward good behavior and highlight desired behaviors, provide data to guide promotion and transfer decisions, and identify training needs for the agency and individual officers.

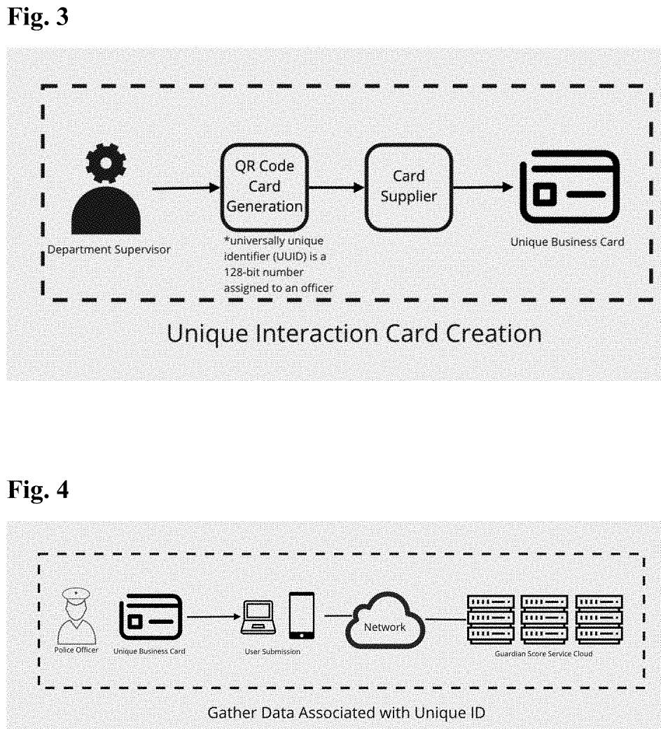

FIG. 3 shows a method for an interaction card creation process, according to an exemplary embodiment. First, a department supervisor generates a unique QR code using the survey tool software. The QR code is a universally unique identifier, which may be a 128-bit number assigned to a particular officer. Then, the QR code is printed on an interaction card, such as a business card. The printing instructions including the QR code, may be sent to a card supplier/vendor to print each interaction card, or printed in-house. Finally, the unique business card (i.e., interaction card) may be distributed to community members, such as described above with respect to the method shown in FIG. 1 and FIG. 2.

FIG. 4 shows a method for a survey data collection process, according to an exemplary embodiment. First, a police officer distributes an interaction card with a unique QR code to a community member or other potential user. This interaction card may be created according to the process described above with reference to FIG. 3. Then, the user scans the QR code and generates data by completing the survey on a website associated with the QR code. The survey data is transmitted to a database or other memory, where it may be accessed by a survey tool software for manipulation and analysis, such as described above with respect to the method shown in FIG. 1 and FIG. 2.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

We claim:

1. A method of verifying encounters used to populate a customer service survey software, the method comprising:
issuing an interaction card having an encounter-specific Quick Response (“QR”) code to a user;
scanning the QR code by the user using an electronic device, the user accessing and completing a customer service survey on the electronic device;
collecting information of the customer service survey of the user by the customer service survey software; and
storing the information as data in a non-transitory computer-based memory in a back-end server.
